(19) United States
(12) Patent Application Publication
(10) Pub. No.: US 2023/0415840 A1
(43) Pub. Date: Dec. 28, 2023

(54) THREE-WHEELED TILTING VEHICLE AND CONTROL SYSTEM

(71) Applicant: Robert Frank Hoskin, Lawrenceville, GA (US)

(72) Inventor: Robert Frank Hoskin, Lawrenceville, GA (US)

(21) Appl. No.: 18/182,322

(22) Filed: Mar. 11, 2023

Related U.S. Application Data
(60) Provisional application No. 63/329,771, filed on Apr. 11, 2022.

(51) Int. Cl. B62K 5/023; B62K 5/05; B62K 5/06; B62K 25/04; B62K 5/08

(52) U.S. Cl. CPC B62K 5/023; B62K 5/05; B62K 5/08; B62K 25/04; B62K 5/06

(57) ABSTRACT

Disclosed are various embodiments of a tilting frame for a three-wheeled vehicle with a steerable load-carrying front end. When the vehicle is rolling forward and steered, the wheels and portions of the frame can tilt sideward in a controlled manner to provide turning stability. Further, the frame keeps the load in a substantially-level and fully supported while also causing the vehicle and load center of gravity to shift laterally to enhance vehicle stability. An embodiment of the invention relates to human pedaled and electric-assisted vehicles including cargo bikes and trishaws for carrying passengers.

### FIELD OF INVENTION

Embodiments of the invention provide a tilting frame for a three-wheeled vehicle with a steerable load-carrying front end. When the vehicle is rolling forward and steered, the wheels and portions of the frame can tilt in a controlled manner to provide turning stability. Further, the frame keeps the load in a substantially-level and fully supported while also causing the vehicle and load center of gravity to shift laterally to enhance vehicle stability. An embodiment of the invention relates to human pedaled and electric-assisted vehicles including cargo bikes and trishaws for carrying passengers.

### BACKGROUND OF INVENTION

Various types of vehicles have been proposed that have tilting frames and tilting wheels to increase stability while turning. For example, U.S. Pat. No. 10,787,217 B2 to Mogensen and U.S. Pat. No. 7,487,985 B1 to Mighell disclose three-wheeled vehicles with tilting frames that include parallelogram structural members. The embodiments disclosed by Mogensen and Mighell require the driver to control the tilting of the vehicle when turning. This requires the driver to balance their own weight, the weight of the vehicle and the weight of any additional load being carried upon the vehicle. These prior-art vehicles balance in a manner similar to a bicycle, but balancing heavy loads at low speeds can be difficult or impossible in certain situations. When balance is lost the vehicle frame can dangerously tip to one side or the other thus upsetting the load and/or passengers.

Three-wheeled cargo bikes are also known in the art. U.S. patent application Ser. No. 16/523,844 to Mauck discloses a three-wheeled cargo bike with a structural frame. The embodiments described by Mauck have two front wheels, one rear wheel, a front frame and a plurality of suspension members having a plurality of kingpins. The kingpins are attached to the sides of the front frame, arranged to steer the front wheels and turn the vehicle. When the front wheels are steered, sideward wheel and rear frame tilting are provided to improve vehicle stability. However, the kingpin vertical angles are fixed and thus the wheel and frame tilting vary only with steering angle and not speed. Thus, the amount of wheel and frame tilting do not always correspond to the sideward tilt that would be needed to balance a bicycle under the same conditions. This can cause an unnatural, unbalanced ride sensation to the driver.

Another type of prior-art three-wheeled cargo bike is disclosed in German Patent Application DE102004042844 to Winther. Winther discloses a cargo bike which has a frame with a rear wheel, seat tube and saddle, a front load box with two coaxial wheels, and a u-shaped handlebar (called a “guide bracket”) mounted to the load box on its rear upper edge. The vehicle is steered by rotating the handlebar and front load box around a vertical swivel joint located at the front of the frame. This arrangement causes the turning radius of all wheels to intersect at a single point thus avoiding wheels scrub. The frame includes a semi-circular track and rollers which purportedly increase the bending stiffness of the forward frame and avoids frame flexing near the vertical swivel joint.

U.S. Pat. No. 8,641,064 B2 to Krajekian discloses a tilting multi-wheeled vehicle that includes a tilting frame supporting at least one seat; a body; and a suspension assembly, wherein the suspension assembly is structured and arranged to permit a transversely disposed pair of the wheels to tilt with the tilting frame. While the tilting frame tilts, the body remains in a controlled relationship with the tilting frame. The controlled relationship with the tilting frame purportedly permits the vehicle body to remain substantially parallel to the road surface. However, the illustrations in this patent show that the body actually tilts away from the direction that would be desired, e.g., the body tilts away from the turn rather than into the turn. Therefore, the claim that the “vehicle body remains substantially parallel to the road surface” is inaccurate for this prior-art vehicle.

U.S. Pat. No. 6,015,186 to Grieger discloses a folding bench seat for vehicles with a base frame that has a fixed structure when in use.

U.S. Pat. No. 11,260,784 to Staal discloses a three-wheeled vehicle for carrying passengers that includes a seating surface and a moveable footrest below the seating surface. The footrest is upwardly and downwardly moveable from a loading/unloading position to a transport position that is closer to the seating surface than the loading/unloading position. A similar moveable footrest is described in literature for a prior-art commercially-available three-wheeled vehicle with trade name Van Raam Chat. On both vehicles a passenger footrest is in an upper position for traveling, and in a lower position at ground level for loading and unloading. This prior-art footrest improves passenger accessibility. However, when the prior-art footrest is in the loading and unloading position it blocks direct access to the passenger seat for passengers who utilize wheeled walkers or personal scooters.

There is a need in the art for a three-wheeled vehicle that provides controlled tilting as a function of speed and steering angle while also safely carrying heavy loads or passengers and supporting the load or passengers in a substantially level position. There is also a need in the art for a vehicle footrest that supports passenger's feet when traveling, but then can be positioned such that passengers have direct assess to the passenger seat.

### SUMMARY OF THE INVENTION

It is an object of the present invention to provide a three-wheeled vehicle with a single rear wheel mounted to a rearward frame and two coaxial front wheels mounted to a steerable front frame that can safely support a heavy load including passengers. A further object of the invention is to provide controlled tilting of the rear frame and all wheels to provide stability when the vehicle is steered. The vehicle is steered to a desired steering angle by pivoting the front frame around a joint located at the forward end of the rearward frame. When steered, portions of the forward frame remain substantially level and fully supported by the front wheels and a plurality of suspension springs while the rearward frame and wheels are tilted into the steered turn similar to turning a bicycle. A central gimbal provides a means for the vehicle tilt to be controlled by the steering angle, and also provides a means for the vehicle tilt to be matched to the vehicle speed to compensate for lateral forces when turning in the manner of a bicycle. A further object of the invention is to provide a method for steering and tilting a three-wheeled vehicle with an articulated frame. These and other aspects of the present invention are further described in the remainder of this disclosure. Embodiments of the invention can include three-wheeled vehicles known as trishaws for transporting human passengers.

### BRIEF DESCRIPTION OF THE DRAWINGS

The foregoing and other aspects of the present invention will be better understood from the following detailed description with reference to the following drawings:

FIG. 1 is a front, right, isometric view of a tilting three-wheeled vehicle in accordance with an embodiment of the present invention.

FIG. 2 is a front, right, isometric view of a midframe portion of a rearward frame of the present invention wherein a gimbal actuator positions a gimbal at zero degrees of forward tilt.

FIG. 3A is a front, right, isometric view of a midframe portion of a rearward frame of the present invention wherein a gimbal actuator positions a gimbal at thirty-five degrees of forward tilt.

FIG. 3B is a close-up view of the right portion of FIG. 3A.

FIG. 4A is a mostly-forward, slightly right isometric view of the midframe portion of FIG. 3A further including two forward frame struts.

FIG. 4B is the mostly-forward, slightly right isometric view of the midframe portion of FIG. 3B further including two forward frame struts.

FIG. 5 is the mostly-forward, slightly right isometric view of the midframe portion of FIG. 4B further including upper and lower headpost caps.

FIG. 6 is the mostly-forward, slightly right isometric view of the midframe portion of FIG. 5 further including forward frame upper and lower suspension arms.

FIG. 7 is the mostly-forward, slightly right isometric view of the midframe and forward frame components of FIG. 6 wherein the suspension arms are rotated thirty degrees to the right.

FIG. 8 is the mostly-forward, slightly right isometric view of the midframe and forward frame components of FIG. 7 further including left and right wheel-footrest frames.

FIG. 9 is the mostly-forward, slightly right isometric view of the midframe and forward frame components of FIG. 8 further including left and right front wheels.

FIG. 10A is an isometric view of a gimbal roller assembly of the present invention.

FIG. 10B is an isometric view of the gimbal roller assembly of FIG. wherein the gimbal wheel is swiveled in a perpendicular direction provided by a spherical bearing.

FIG. 11A is a front, left, isometric view of a midframe portion of a rearward frame of the present invention wherein additional steering components are illustrated.

FIG. 11B is a front, right, isometric view of FIG. 11A.

FIG. 11C is a closeup view of FIG. 11A.

FIG. 12A is a front, right, and downward isometric view of FIG. 9 that includes steering components of FIG. 11A further including the rear frame portion of the rearward frame that includes a seat and rear wheel.

FIG. 12B is a front, right, isometric view of FIG. 12A.

FIG. 12C is a rear view of FIG. 12A.

FIG. 12D is a top view of FIG. 12A.

FIG. 13A is a front, right, isometric view of FIG. 12B further including seat spring struts for supporting a seat frame.

FIG. 13B is the view of FIG. 13A further including a seat frame mounted to the seat spring struts.

FIG. 14 is the view of FIG. 13B further including a tilt actuator and mounting brackets attached to upper and lower suspension arms.

FIG. 15A is a diagrammatic front view illustration of forward frame components of the invention in non-tilted positions.

FIG. 15B is a diagrammatic front view illustration of forward frame components of the invention in left-turn tilted positions.

FIG. 15C is a diagrammatic front view illustration of forward frame components of the invention in right-turn tilted positions.

FIG. 16A is a front, right, isometric view of an embodiment of the invention that includes an electronic enclosure to house tilt control electronics including a microcomputer.

FIG. 16B is a close-up top isometric view of the electronic enclosure of FIG. 16A with the enclosure top cover removed showing a microcomputer and motor drive units.

FIG. 17 is a closeup view of a rear wheel of the invention showing a hall effect sensor and magnets.

FIG. 18 is a top, right isometric view of the midframe portion of FIG. 11C further showing a linear variable differential transducer and its mounting brackets.

FIG. 19 is an alternate embodiment of the lower steering link previously illustrated in FIG. 11C.

FIG. 20A is the three-wheeled vehicle of FIG. 1 with a footboard assembly rotated to a downward position to facilitate loading and unloading passengers.

FIG. 20B is a right-side view of FIG. 17A.

FIG. 20C is a right-side view of FIG. 1 with the footboard assembly in an upper, traveling position.

FIG. 21 is a front, left view of FIG. 12A further including the footboard assembly in an upper, traveling position.

FIG. 22 is the view of FIG. 1 further including protective and decorative covers on the footboard assembly.

### DETAILED DESCRIPTION OF THE INVENTION

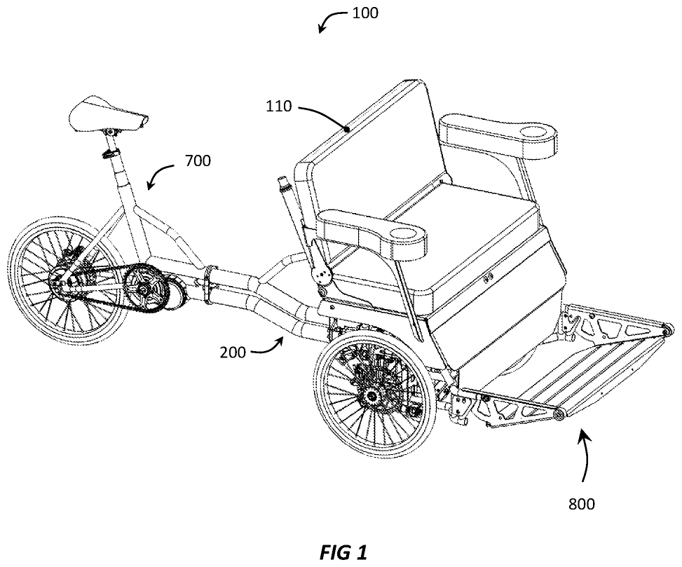

Referring to FIG. 1, a tilting three-wheeled vehicle is shown that includes a seat assembly 110, a midframe portion 200 a rear frame portion 700, and a footboard assembly 800. Midframe portion 200 and rear frame portion 700 are collectively referred to as the rearward frame. Footboard assembly 800 is shown in an upward position that allows passengers to support their feet thereon.

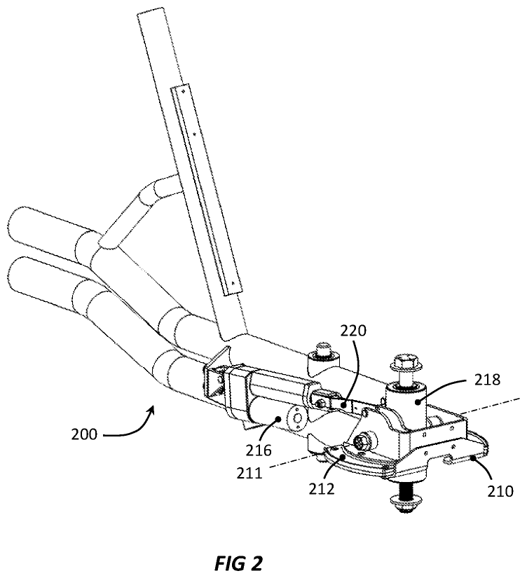

Referring to FIG. 2, midframe portion 200 is shown with additional components mounted or attached thereon. Additional components shown include a headpost 218 at the forward end of midframe 200. A gimbal assembly 210 is pivotally attached to headpost 218 on a horizontal axis 211. The aft end of a gimbal actuator 216 is pivotally attached to midframe 200 using a suitable clevis arrangement. The forward end of gimbal actuator 216 includes a bracket 220 that is pivotally attached to gimbal assembly 210 with a suitable pin and bushing. Gimbal assembly 210 further includes two semi-circular tracks 212 on the left and right sides. The gimbal assembly is shown in a position that represents zero degrees of rotation about horizontal axis 211. In this position the upper surfaces of gimbal tracks 212 are substantially horizontal.

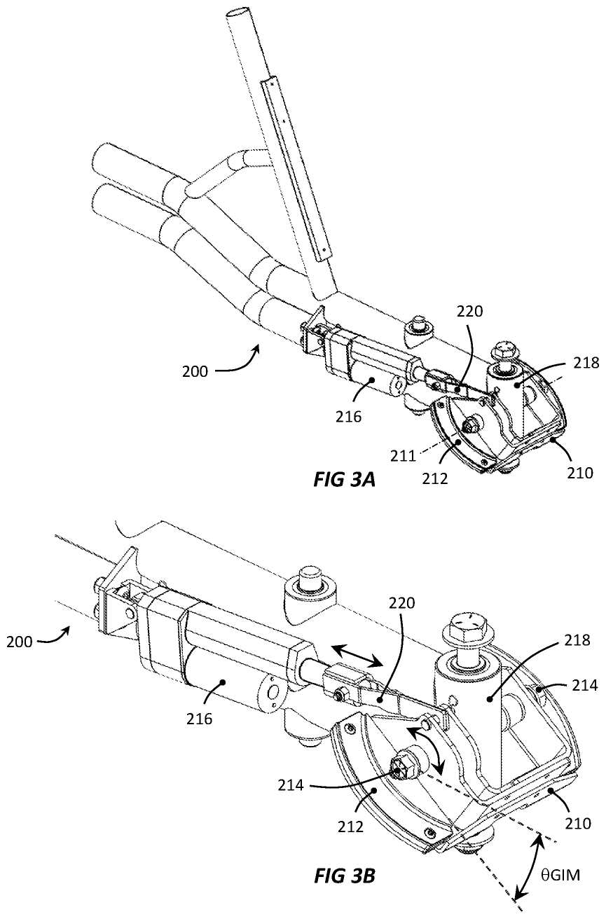

Referring to FIG. 3A, midframe portion 200 is shown with gimbal assembly 210 rotated to a forward-tilted angle, θGIM, of approximately 35 degrees. This is accomplished by extending gimbal actuator 216 by approximately 1 inch.

Referring to FIG. 3B, bolts 214 with suitable bushings constrain gimbal assembly 210 rotation about horizontal axis 211.

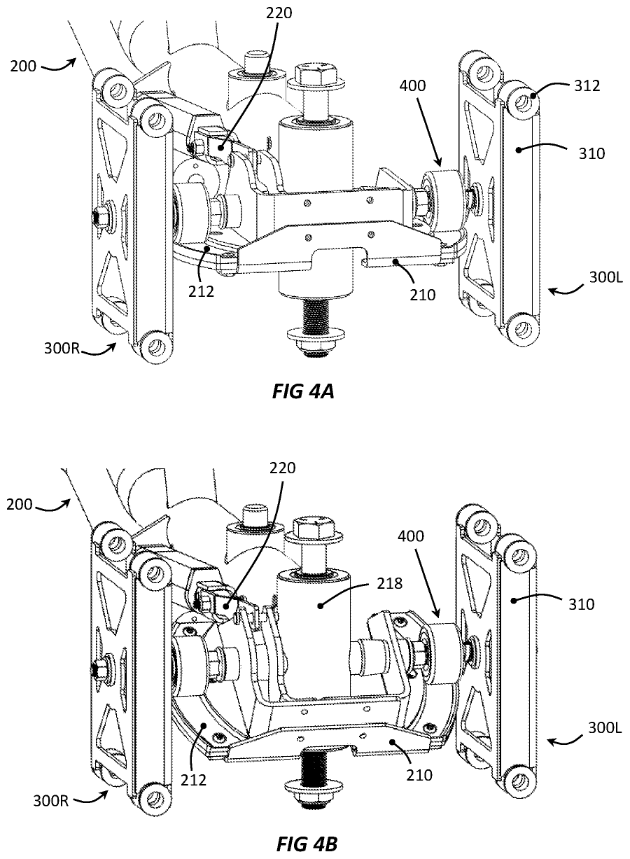

Referring to FIG. 4A, the midframe portion and components of FIG. 2 are shown further including two forward frame struts 300L and 300R, each with a gimbal roller assembly 400 mounted thereon. The forward frame struts include a body 310 and bushings 312. The forward frame struts 300L and 300R are positioned such that the cylindrical roller surfaces of the gimbal roller assemblies engage the semi-circular tracks 212 on the left and right sides of gimbal assembly 210. The centerline axes of the gimbal roller assemblies 400 are colinear with horizontal axis 211 in this figure.

Referring to FIG. 4B, the midframe portion and components of FIG. 4A are shown with gimbal assembly 210 rotated forward, and gimbal actuator 216 extended in the manner of FIG. 3A and FIG. 3B.

Referring to FIG. 5, the midframe portion and components of FIG. 4B are shown further including upper and lower headpost caps 420 that include tabs 422. Headpost caps 420 are pivotally mounted to headpost 218 using headpost bolt 414 and suitable bearings mounted in headpost 218.

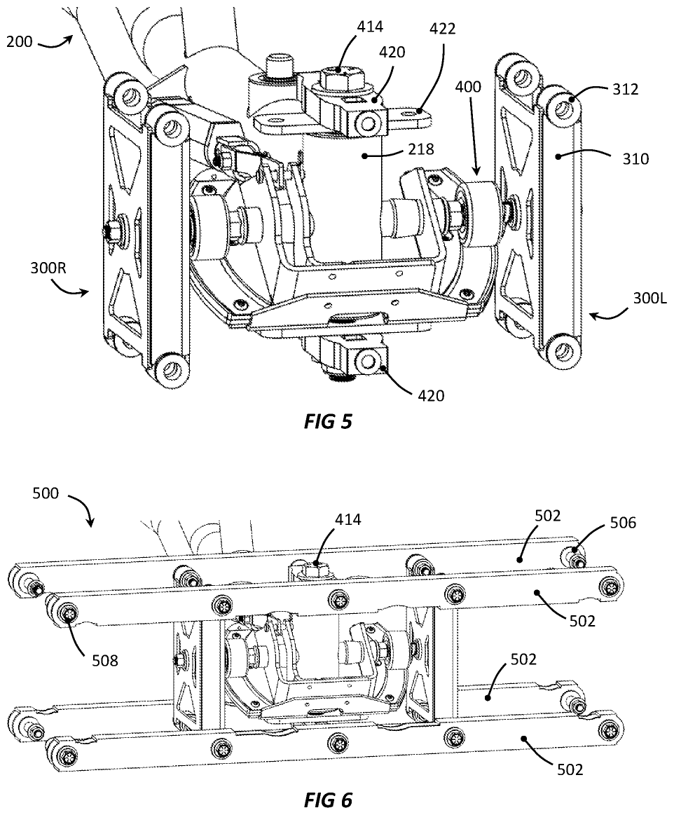

Referring to FIG. 6, the midframe portion and components of FIG. 5 are shown further including a suspension arm group 500 comprised of four suspension arms 502. A plurality of bushings 506 mounted within parallel holes that are aligned along the length of suspension arms 502. Bolts 508 extend through each bushing 506. Wheel frames 600L and 600R pivotally mount to the end holes. Forward frame struts 300L and 300R pivotally mount in the intermediate holes. Headposts caps 420 pivotally mount to the suspension arms and form short beams between the center holes of the upper suspension arms and also between the center holes of the lower suspension arms. Wheel frames 600L and 600R, suspension arm group 500, forward frame struts 300L and 300R, and headpost caps 420 collectively cooperate in a geometric and structural manner to function as a forward frame articulated rectangular parallelogram structure.

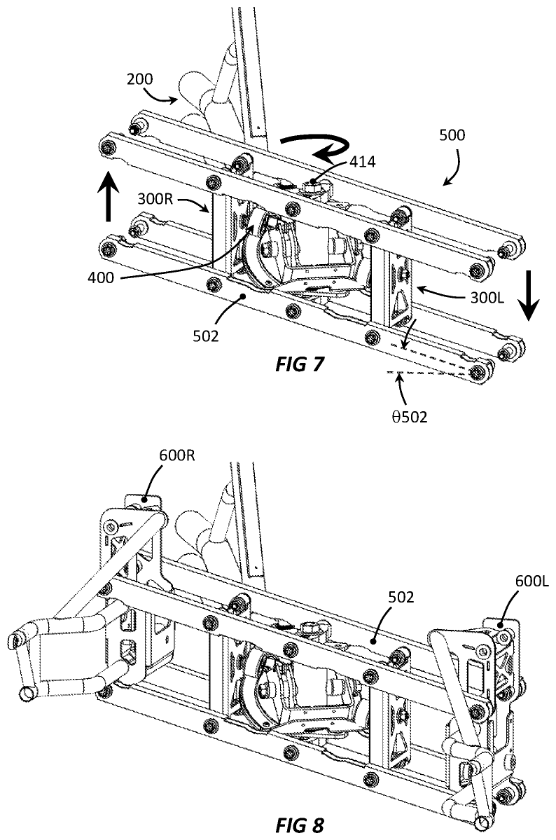

Referring to FIG. 7, the midframe portion and components of FIG. 6 are shown with forward frame struts 300L and 300R, gimbal roller assemblies 400, headpost caps 420 and suspension arm group 500 collectively rotated about headpost bolt 414 in the direction of the rotational arrow shown. Headpost bolt 414 is thus the rotational axis of a vehicle steering joint. This rotational direction corresponds to the three-wheeled vehicle 100 turning to the right. As this right-turn rotation about headpost bolt 414 occurs, the cylindrical roller surface of gimbal roller assembly 400 (attached to strut 300R) climbs up semi-circular track 212 on the right side of gimbal assembly 210. This climbing motion pushes strut 300R in an upward direction as shown by the directional arrow. The forward frame parallelogram structural arrangement causes strut 300L to simultaneously move downward thereby causing the cylindrical rolling surface of gimbal roller assembly 400 (attached to strut 300L) to roll down semi-circular track 212 on the left side of gimbal assembly 210. The forward frame parallelogram structure is thus urged and moved into a trapezoidal shape. Suspension arms 502 are rotated to tilt angle θ502 relative to their original horizontal orientation. Struts 300L and 300R move a vertical distance that is commensurate with the forward tilt of gimbal assembly 210. Note that when gimbal assembly 210 is at zero degrees of rotation (FIG. 4A) struts 300L and 300R do not have vertical motion and the forward frame parallelogram structure maintains a rectangular shape. A left-turn rotation about headpost bolt 414 causes component motions in the opposite directions as described for a right-turn rotation.

Referring to FIG. 8, the midframe portion and forward frame components of FIG. 7 are shown further including left and right wheel frames 600L and 600R.

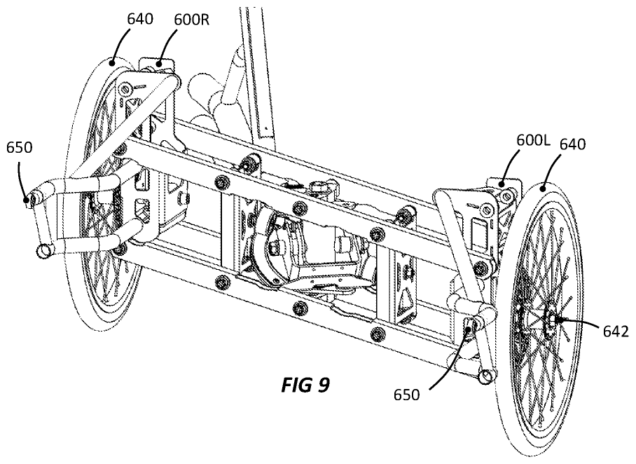

Referring to FIG. 9, the midframe portion and forward frame components of FIG. 8 are shown further including left and right wheels 640 with suitable axle bearings within the wheel hubs. Wheels 640 are attached to wheel frames 600L and 600R using bolts 642. Bolts 642 act as axles for wheels 640 thereby allowing the wheels to freely rotate about the bolts 642. Bolts 642 are positioned on wheel frames 600L and 600R such that the wheel rotational axes are located slightly aft of the vertical axis of headpost bolt 414. This causes wheels 640 to have positive steering caster relative to bolt 414. Ball joints 650 are mounted at the front of wheel frames 600L and 600R and will be referred to later in this disclosure.

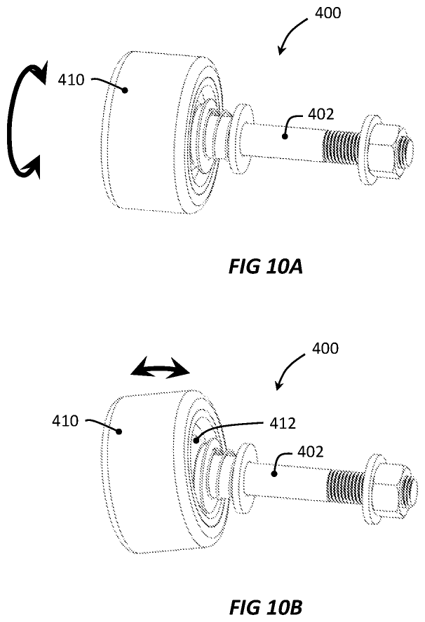

Referring to FIG. 10A and FIG. 10B further details of gimbal roller assemblies 400 are shown. Gimbal roller assemblies 400 include a gimbal shaft 402, a gimbal wheel 410, and a spherical bearing 412. Spherical bearing 412 is incorporated into a co-linear bearing arrangement that allows three types of motion: (i) rotary motion of gimbal wheel 410 about a horizontal axis (colinear with shaft 402 in FIG. 10A); (ii) motion comprising linear travel of gimbal wheel 410 along shaft 402; and (iii) a tilting motion of gimbal wheel 410 about spherical bearing 412 (FIG. 10B). This co-linear bearing arrangement allows the rolling surface of gimbal wheel 410 to remain aligned with gimbal tracks 212 when the steering motions described in FIGS. 7-9 are accomplished.

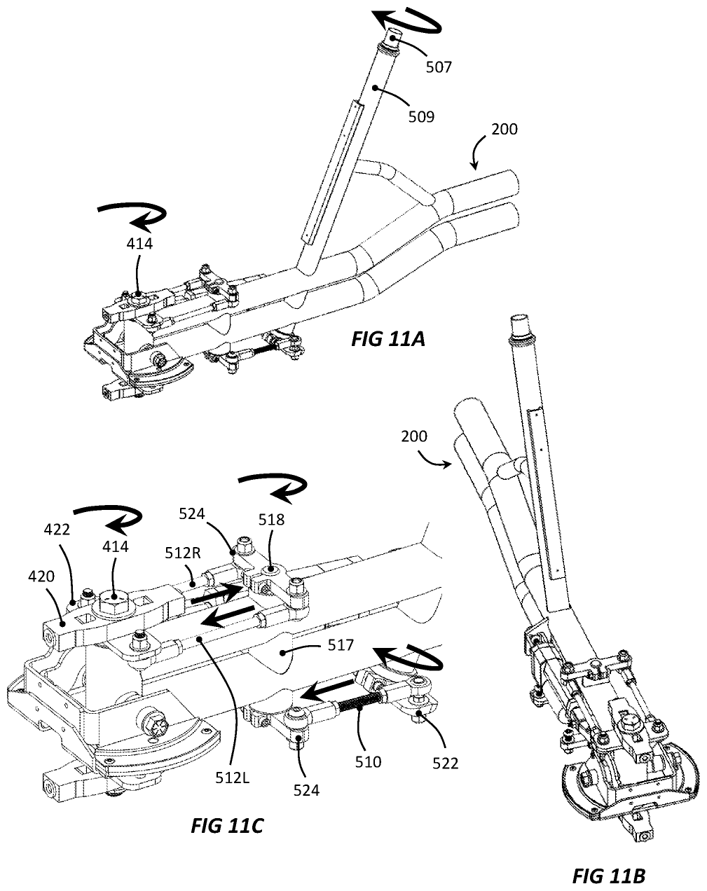

Referring to FIG. 11A, FIG. 11B and FIG. 11C, isometric views of midframe portion 200 are shown further including additional steering components. Steering tube 507 is located inside handlebar tube 509 mounted near the center of midframe portion 200. Steering tube 507 rotates about its center axis on suitable bearings at the top and bottom of tube 509. A suitable handlebar riser (such as a folding bicycle stem) and suitable handlebars can be mounted to the top of steering tube 507. Rear steering crank 522 is mounted to the bottom end of steering tube 507. The left end of rear steering crank 522 is pivotally attached to the aft end of lower steering link 510. Rotary motion of steering tube 507 is transformed into lower steering link 510 linear-rotational motion. Lower steering link 510 is equipped with ball joints at each end to enable pivoting motion and to accommodate the non-vertical angle of tubes 507 and 509. The forward end of lower steering link 510 is pivotally attached to the left end of forward crank arm 524 which is mounted to the lower end of midframe shaft 518. Midframe shaft 518 is rotationally mounted within midframe shaft tube 517 using suitable bearings. A second forward crank arm is mounted to the upper end of shaft 518. This arrangement transfers the linear-rotation motion of lower steering link 510 to rotary motion of the upper forward crank arm 524. The aft ends of upper steering links 512L and 512R pivotally attach to the ends of upper forward crank arm 524. Upper steering links 512L and 512R are equipped with ball joints at each end to enable pivoting motion. The forward ends of upper steering links 512L and 512R pivotally attach to tabs 422 of upper headpost cap 420. Rotary motion of headpost caps 420 about headpost steering bolt 414 was described earlier as left-turn and right-turn rotations (ref. FIG. 7). Thus, the steering components described in FIGS. 11A-11C transfer torque and rotation of steering tube 507 into forces causing left-turn and right-turn rotations of forward frame components, and thereby enable the driver of the three-wheeled vehicle 100 to steer it left and right using handlebars.

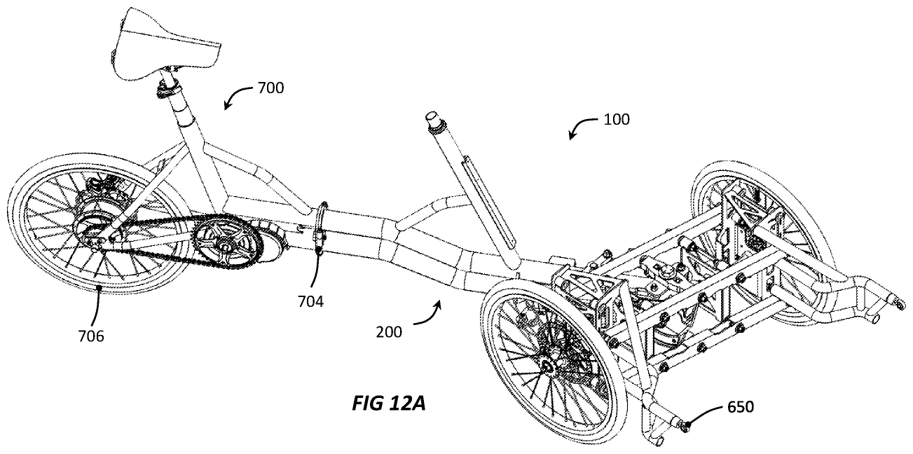

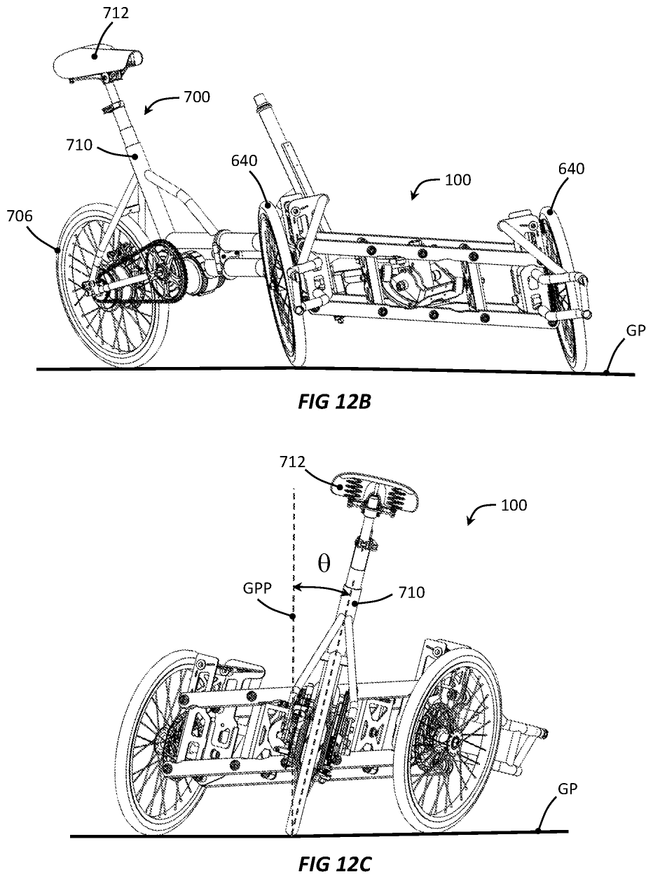

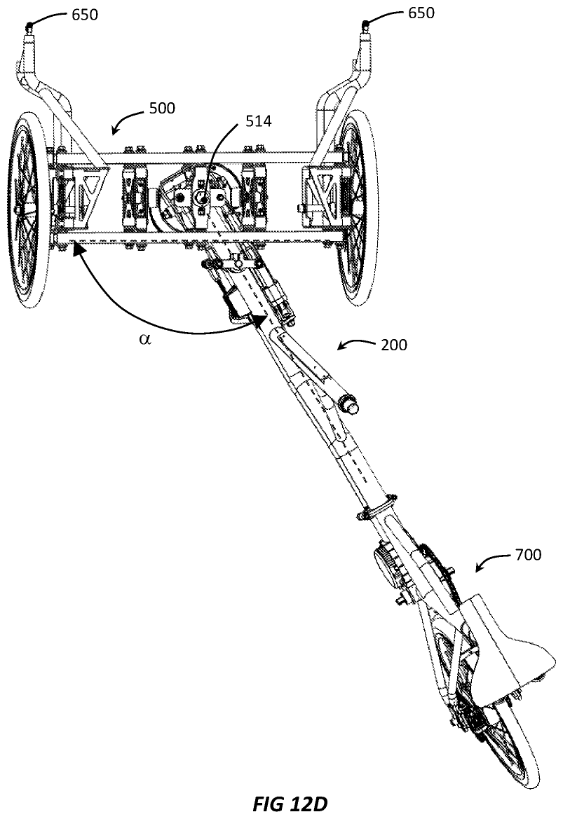

Referring to FIG. 12A, an isometric view of the components of FIG. 9 are shown further including rear frame portion 700. A folding joint 704 is shown which connects rear frame portion 700 to midframe portion 200. Recall that midframe portion 200 and rear frame portion 700 are collectively referred to as the rearward frame. Rear frame portion 700 includes a rear wheel 706.

Referring to FIGS. 12B and 12C, the three-wheeled vehicle 100 is shown with front wheels 640 and rear wheel 706 resting upon a ground plane GP. The aforementioned gimbal assembly forward tilting (ref. FIG. 3A) and right-turn rotation (ref. FIG. 7) cause the rearward frame to tilt sideward at an angle θ relative to an axis GPP that is perpendicular to ground plane GP. Forward wheels 640 are also caused to tilt at an angle that is similar and complementary to tilt angle θ.

Referring to FIG. 12D, the three-wheeled vehicle of FIG. 12C is shown in a top view. As the vehicle is turned right to a steering angle a, corresponding rearward frame right-tilt θ is produced. Forward wheels 640 are also tilted to the right. It can thus be seen that the three-wheeled vehicle can be tilted in the manner of a bicycle when turning, thus significantly enhancing vehicle stability. The amount of sideward tilt θ that is caused by a given steering angle c, is explicitly determined by the forward tilt angle of the gimbal assembly. This relationship will be further described later in this disclosure.

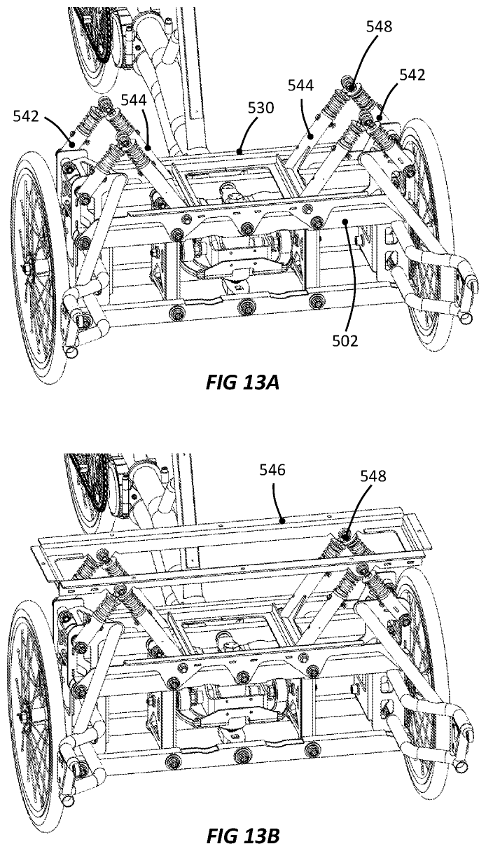

Referring to FIG. 13A, the three-wheeled vehicle of FIG. 12D is shown in a front isometric view further including additional components. Seat subframe 530 mounts to the upper suspension arms 502. Two inner spring strut assemblies 544 pivotally attach to seat subframe 530. Four outer spring strut assemblies 542 pivotally attach to the top of wheel frames 600L and 600R. Ball joints are mounted to the top ends of spring struts 544 and 542, and the tops of adjoining spring struts are pivotally connected to each other using bolts 548.

Referring to FIG. 13B, the three-wheeled vehicle of FIG. 13A is shown, further including a seat frame 546. Seat frame 546 mounts to spring strut 542 and 544 using bolts 548. Seat subframe 530, inner spring strut assemblies 544, outer spring strut assemblies 542 and wheel plates 600L and 600R collectively provide an articulated dual four-bar seat suspension structure whereby the seat frame 530 is kept substantially level when the three-wheeled vehicle tilts. Seat assembly 110 (ref. FIG. 1) can be suitably mounted to an upper portion of seat frame 546 thereby providing the seat assembly with a self-leveling spring suspension. Note that in an alternate embodiment of the invention, the midframe portion steering components (ref. FIG. 11C) can be omitted, and a handlebar attached to the rear of seat assembly in the manner disclosed by Winther. In this alternate embodiment, steering forces are transferred from the handlebar into the seat assembly thereby rotating the seat assembly and the forward frame components about headpost steering bolt 414 to provide vehicle steering. Also note that in another alternate embodiment the seat assembly 110 can be mounted directly to and above the upper suspension arms using a fixed base in the manner disclosed by Grieger. Also note that in other alternate embodiments a suitable box or platform can be mounted to and above seat frame 546 or to and above the upper suspension arms thereby providing cargo bike configurations.

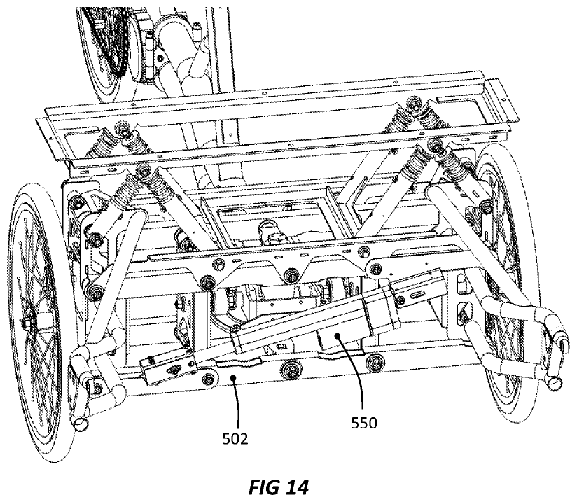

Referring to FIG. 14, the three-wheeled vehicle of FIG. 13B is shown, further including a tilt actuator 550. The upper end of tilt actuator 550 is pivotally attached to one end of forward upper suspension arm 502 using a suitable bracket. The lower end of tilt actuator 550 is attached to the opposing end of forward lower suspension arm 502 using a suitable bracket. The purpose of tilt actuator 550 will be further described later in this disclosure.

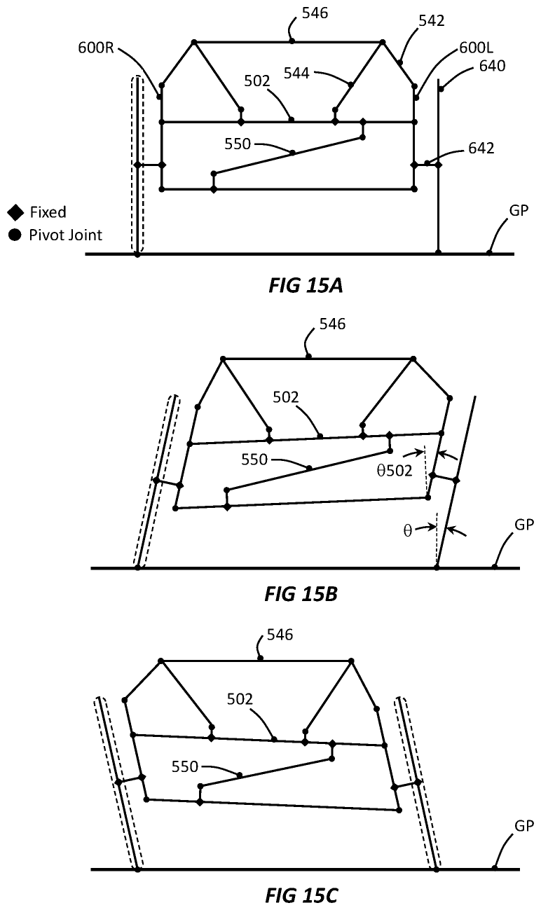

Referring to FIG. 15A, a diagrammatic front view of forward frame components of the invention in non-tilted positions is shown. This represents the forward frame of the three-wheeled vehicle when traveling in a straight forward direction with steering angle α equal to zero degrees.

Referring to FIG. 15B, the diagrammatic front view of FIG. 15A is shown according to a turn-left rotation of the forward frame components. Front wheels 640 and suspension arms 502 tilt in the manner as earlier described, and the parallelogram structure becomes trapezoidal. The angle of wheel frame 600L from its original perpendicular position is θ502. Note that θ502>θ because of the length of axles 642. The geometric arrangement of the upper suspension arms 502, inner spring struts 544, outer spring struts 542 and wheel frames 600L, 600R provide a plurality of four bar mechanisms that cause seat frame 546 to remain substantially parallel with ground plane GP. A seat assembly mounted to seat frame 546 would therefore remain level during when the vehicle is steered left. Note that the geometric arrangement of tilt actuator 550 requires it to be extended as compared to FIG. 15A.

Referring to FIG. 15C, the diagrammatic front view of FIG. 15A is shown according to a turn-right rotation of the forward frame components. Component tilting is opposite that shown in FIG. 15B, and tilt actuator 550 is retracted as compared to FIG. 15A. As with FIG. 15B, the seat frame 546 remains substantially parallel with ground plane GP.

The function of the tilt actuator 550 is now further described. Driving experiments with a prototype of the invention revealed that steering forces can be excessive in certain situations with gimbal assembly forward rotations of about 5 degrees or greater and/or heavy passenger loads. Tilt actuator 500 can be provided with its extension-retraction coordinated with extension-retraction of gimbal actuator 216 according to changes in steering angle α. Tilt actuator 550 can thereby provide power-assisted tilting when the vehicle is steered.

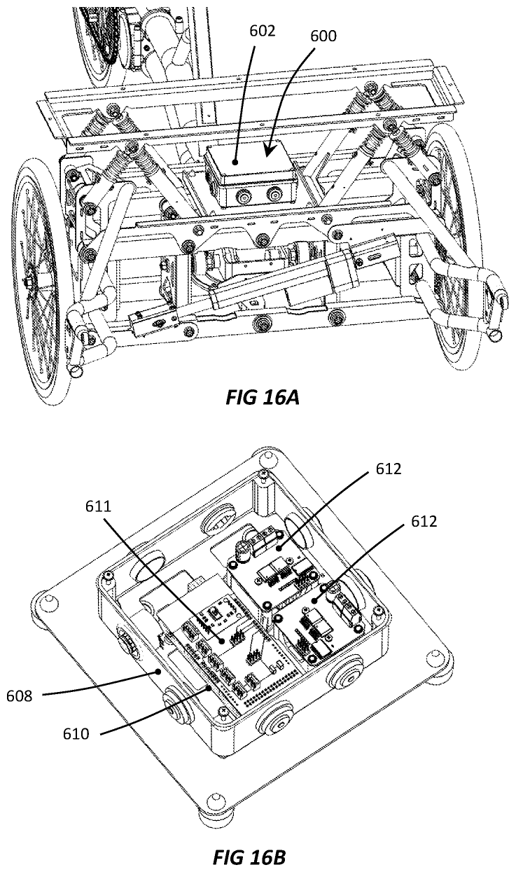

Referring to FIG. 16A, the three-wheeled vehicle of FIG. 14 is shown, further including an electronic enclosure 600 with lid 602. The purpose of the electronic enclosure is to house a microcomputer and motor drive units which will be further described.

Referring to FIG. 16B, an isometric view is shown of an electronic enclosure 600 with lid 602 removed. Microcomputer 610 and motor drive units 612 mount inside housing 608. An exemplary microcomputer is an Arduino Mega microcomputer as is known in the electronics trade. Microcomputer 610 can include an interface board 611 for connecting to motors and sensors as illustrated in FIG. 16B. Note that in FIG. 16B microcomputer 610 is beneath interface board 611. Microcomputer 610, interface board 611 and motor drive units 612 are collectively referred to as a control unit.

Referring to FIG. 17, a closeup of the hub of wheel 706 (ref FIG. 12A) is shown. The rear wheel hub of rear wheel 706 is mounted to rear frame portion 700 in a manner that is known in the art. The wheel hub includes a brake disc 724 mounted thereon in a manner that is known in the art. A plurality of magnets 720 mount within a bracket that co-mounts with brake disc 724. In a preferred embodiment six magnets are used. Magnets 724 are arranged to pass by hall effect sensor 730 as the wheel rotates about axle 713. Hall effect sensor 730 can be used to detect the passing of each magnet, which can be used to determine vehicle speed as will be further described.

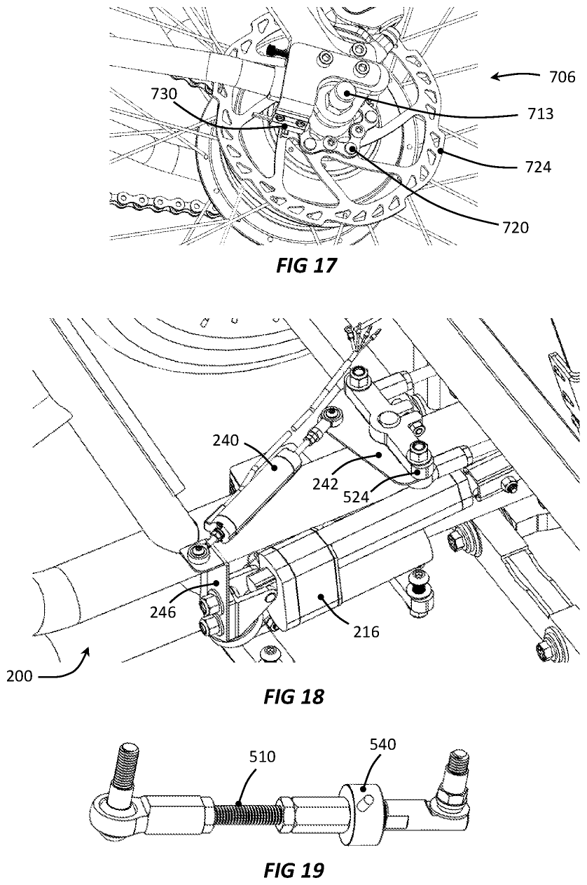

Referring to FIG. 18, a closeup midframe 200 (ref. FIG. 11C) is shown. An embodiment of the invention can include a DC motor linear actuator as is known in the art for gimbal actuator 216. In a preferred embodiment, actuator 216 is a 12 VDC linear actuator configured with an internal potentiometer to provide feedback of actuator ram position. A linear variable differential transformer (LVDT) 240 is shown mounted to midframe portion 200. The forward end of LVDT 240 is pivotally attached to bracket 242. Bracket 242 is mounted to forward steering crank 524. The aft end of LVDT 240 is pivotally attached to bracket 246. Bracket 246 is attached to midframe portion 200. The rotary position of steering crank 524 (ref. FIG. 11C) can be measured by LVDT 240 thus providing a means to measure steering angle a (ref. FIG. 12D). When the vehicle 100 is steered left LVDT 240 is retracted from the position shown. When the vehicle 100 is steered right LVDT 240 is extended from the position shown.

Referring to FIG. 19, an alternate embodiment of lower steering link 510 (ref. FIG. 11C) is shown. In the alternate embodiment a load cell 540 is included as part of steering link 510. The purpose of the load cell is to measure steering forces imparted by the driver through the vehicle handlebars. For example, tension is created in steering link 510 when the driver turns the vehicle leftward. Similarly, compression is created in steering link 510 when the driver turns the vehicle rightward. The amount of tension or compression is an indication of the urgency with which the driver intends to turn. The purpose of the load cell and tension-compression forces will be further described.

Referring to all preceding figures, a vehicle tilt control system of the invention is now described. The purpose of the vehicle tilt control system is to tilt portions of the three-wheeled vehicle 100 when turning in a manner that is similar to tilting a bicycle. The three-wheeled vehicle 100 has a longitudinal axis in the direction of vehicle travel over ground plane GP and a lateral axis perpendicular to the longitudinal axis. The amount of vehicle sideward tilt, θ (ref. FIG. 12C) that is required when turning can be described by equation (1):

$$θ = {tan}^{- 1} ( \frac{( tan α ) {V}^{2}}{gW} ) \qquad ( 1 )$$

where α is the vehicle steering angle (ref. FIG. 12D), V is the vehicle speed, g is the acceleration due to gravity, and W is the vehicle wheelbase. The vehicle sideward tilt θ compensates for lateral forces that occur when turning the vehicle. Sideward tilt θ causes the seat 712 to move laterally in the direction of the turn thus causing the combined center of gravity of the vehicle and a person sitting on seat 712 to move laterally by an offset distance relative to ground plane perpendicular axis GPP in the direction of the turn—similar to the effect of tilting a bicycle. Sideward tilt θ may be adjusted so that the lateral turning accelerations acting on the combined center of gravity are compensated by vertical accelerations due to gravity acting upon the combined center of gravity and its lateral offset distance relative to axis GPP.

For the three-wheeled vehicle 100 the wheelbase W is the perpendicular distance between the rear wheel axle 713 (ref. FIG. 17) and the headpost steering bolt 414 (ref. FIG. 11C). The amount of gimbal assembly 210 rotation, OGIM (ref. FIG. 3B), required to tilt the suspension arms 502 of the forward frame by an amount θ502 (ref. FIG. 7) is described by equation (2):

θGIM=sin⁻¹(sin(θ502)/sin α) (2)

Note that θGIM may be limited to a range of about 0 to 35 degrees due to physical constraints on tilting the gimbal assembly 210. Vehicle sideward tilt θ is related to suspension arm tilt θ502 by equation (3):

For small angles θ502, the relationship can be approximated by equation (4):

θ502=1.2 θ (4)

Equations (1), (2) and (4) can be suitably implemented in machine code on microcomputer 610 (ref. FIG. 16B). For equation (1), steering angle α is measured using LDVT 240 (ref. FIG. 18) connected to a first analog input of microcomputer 610. Vehicle velocity V is calculated using hall effect sensor 730 (ref. FIG. 17) connected to a first digital interrupt input of microcomputer 610. The interrupt circuit of microcomputer 610 measures the time between magnets 720 passing hall effect sensor 730. Vehicle speed is then calculated using the magnet passing time, the number of magnets and the circumference of rear wheel 706. Next, equation (4) is used to determine the required suspension arm tilt angle θ502. Next, gimbal assembly tilt angle GIM (ref. FIG. 3B) is calculated using equation (2) subject to an allowed range of 0 to about 35 degrees. Microcomputer 610 provides closed-loop position feedback control by commanding gimbal actuator 210 to extend and retract thereby providing the desired angle θGIM. This is accomplished using (i) a first set of pulse-width-modulation digital outputs from microcomputer 610 to a first motor drive unit 612 (ref. FIG. 16B) to drive the gimbal actuator DC motor, (ii) a second analog input of microcomputer 610 connected to the gimbal actuator's internal feedback potentiometer to measure its linear position, and (iii) a geometric relationship that relates the actuator linear position and angle θGIM. Next, microcomputer 610 provides closed-loop position feedback control to extend and retract tilt actuator 550 to aid in providing the desired suspension arm angle θ502. This is accomplished using (i) a second set of pulse-width-modulation digital outputs from microcomputer 610 to a second motor drive unit 612 (ref. FIG. 16B) to drive the tilt actuator DC motor, (ii) a third analog input of microcomputer 610 connected to the tilt actuator's internal feedback potentiometer to measure its linear position, (iii) a geometric relationship that relates the actuator linear position and angle θ502, and (iv) load cell 540 interfaced with a suitable processing circuit module that is connected to a digital input of microcomputer 610. Load cell 540 and its processing circuit module provide a force measurement that indicates whether the vehicle driver desires to turn the vehicle to the left (load cell tensile force) or to the right (load cell compressive force). If a tensile force is measured, the magnitude of the tensile force is used to formulate a command to extend tilt actuator 550 to tilt the vehicle leftward and thus aid in accomplishing a left turn (ref. FIG. 15B). If a compressive force is measured, the magnitude of the compressive force is used to formulate a command to retract tilt actuator 550 to tilt the vehicle rightward and thus aid in accomplishing a right turn (ref. FIG. 15C). Additional code executed by the microcomputer 610 ensures that gimbal actuator 216 and tilt actuator 540 are properly synchronized to prevent binding or incompatible positioning. A control gain can be optionally applied to the load cell force measurements to adjust steering forces. At steering angles less than about 10 degrees a relatively lower gain can be used. This helps stiffen the vehicle steering in the manner of positive steering caster and thus helps ensure vehicle stability at higher speeds. At steering angles greater than about 10 degrees a relatively higher gain can be used. This improves steering responsiveness at lower speeds.

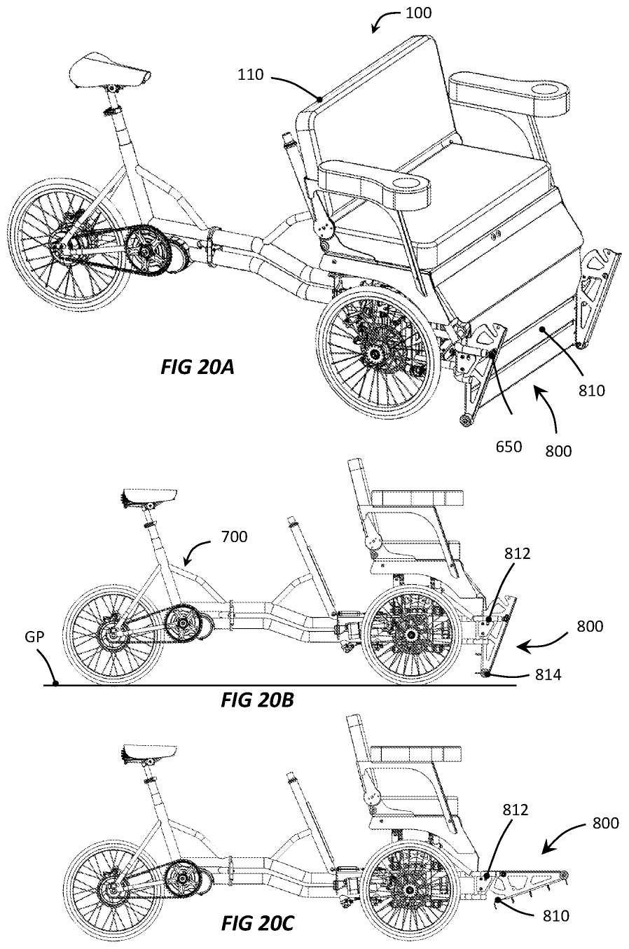

Referring to FIG. 20A, the front, right, isometric view of FIG. 1 is shown with footboard assembly 800 in a rotated downward position. This downward rotation places foot-resting surface 810 in a substantially vertical orientation, and facilitates passenger loading by allowing passengers to back-up closely to the seat surface of seat assembly 110 and then to sit down as in the same manner as sitting upon a chair. Unloading is also facilitated by allowing passengers to exit the vehicle by standing up in the same manner as standing up from a chair. A further advantage is provided to disabled or elderly passengers who must use wheeled walkers to maintain their balance. The footboard arrangement of the present invention allows such a passenger to load and unload without the footboard interfering with their use of the wheeled walker. Similarly, other disabled or elderly passengers who have difficulty walking use a motorized scooter. The footboard arrangement of the present invention allows such a passenger to position the seat of a scooter alongside the front edge of the three-wheeled vehicle seat for easy transfer from and back onto the scooter.

Referring to FIG. 20B, a right-side view of FIG. 20A is shown.

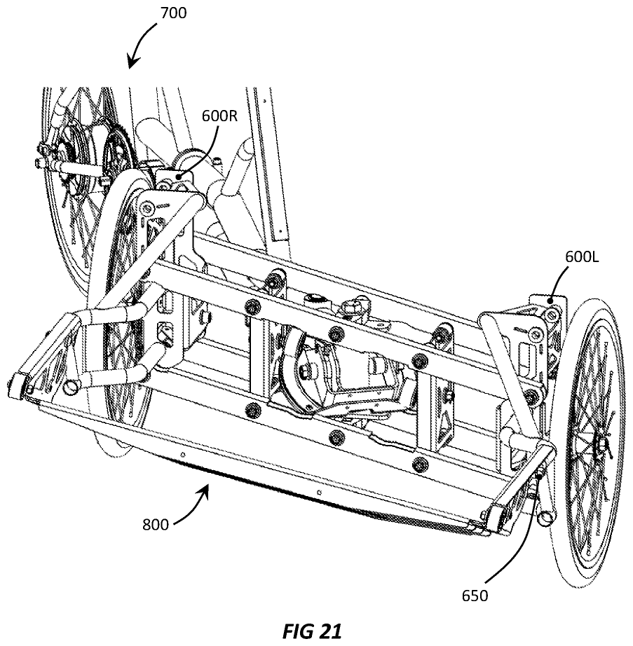

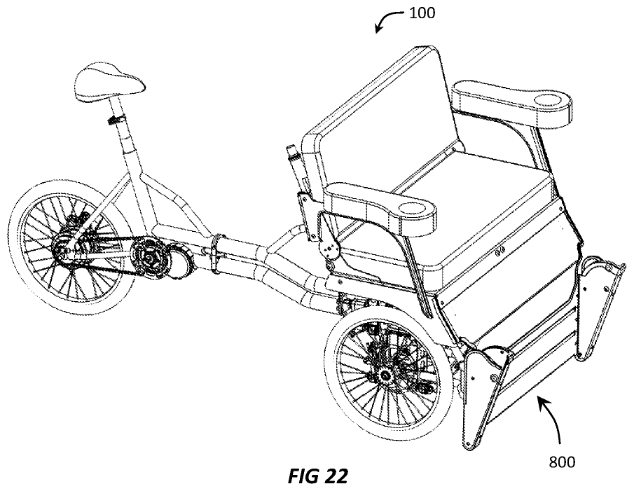

Referring to FIG. 20C, a right-side view of FIG. 1 is shown. Referring to FIG. 20C, the foot-resting surface 810 may be in a predominantly horizontal position or rotated aft of horizontal when in a traveling position. In a preferred embodiment, the foot-resting surface 810 may be inclined in a rearward direction at an angle ranging between about ten and thirty degrees. Referring to FIG. 21, the front, left, isometric view of FIG. 9 is shown further including rear frame portion 700, and footboard assembly 800. Ball joints 650 are mounted at the front of wheel frames 600L and 600R and are used to pivotally attach footboard assembly 800 to wheel frames 600L and 600R. Ball joints 650 allow footboard assembly 800 to articulate in a manner that is compatible with the aforementioned frame tilting (e.g., FIG. 9). This arrangement causes the foot-resting surface 810 of footboard assembly 800 to remain substantially aligned with suspension arms 502 when the three-wheeled vehicle is tilted leftward and rightward as previously described. This arrangement also allows the footboard to be rotated from a traveling position to a loading and unloading position as previously described. Footboard pins 812 fit within enlarged holes in the sides of the footboard and hold the footboard in either the traveling or loading and unloading positions.

In an alternative embodiment, footboard assembly 800 may be installed on a prior-art three wheeled vehicle that does not have a frame with tilting features. Representative vehicles include commercially available vehicles with trade names Triobike Taxi and Nihola Taxi. These prior-art vehicles include a bench-type passenger seat at the forward end in the manner of the present invention. In this alternative embodiment a fixed-position footboard or shelf can be removed and replaced with a rotating footboard assembly 800 of the present invention in front of the passenger seat. Ball joints 650 may be replaced with simple single-axis pivot joints that allow the footboard assembly to rotate between a traveling position to a loading and unloading position thereby providing an improvement to the prior-art vehicle. In an alternative embodiment, the footboard assembly may be installed on a vehicle with four wheels rather than three wheels to improve passenger access for loading and unloading. Such a four-wheeled vehicle could include modified variants of commercially available quadricycles, including quadricycles with trade name Worksman Four Wheel Surrey.

The rotating footboard assembly 800 of the present invention has a further advantage when in the loading and unloading position. Prior-art vehicles such as the Triobike Taxi and the Nihola Taxi are known to tip forward when passengers are loading and unloading if a passenger places their feet and supports their weight on the fixed (non-rotating) footboard. In this scenario the entire vehicle can tip forward on the two forward wheels thereby creating an undesirable and unsafe situation. Embodiments of the present invention can preclude this forward tipping in two ways. First, when the footboard assembly 800 of the present invention is in the loading and unloading position, passengers are not able to place their weight directly on the foot-resting surface 810 because it is in a substantially vertical orientation. Second, referring to FIG. 20B, footboard tips 814 of footboard assembly 800 are adjacent ground plane GP and will contact ground plane GP and act as a tipping restraint if conditions arise that cause the vehicle to tip forward about its front wheels, such as lifting rear frame portion 700 upward.

The present invention provides method for steering and tilting a three-wheeled vehicle operated on a traveling surface. A three wheeled vehicle can include a rearward frame with a single rotatable wheel, and a forward frame including top, bottom, left-end and right-end frame portions. Referring to FIG. 5, forward frame portions are described. A top frame portion can comprise a pair of suspension arms 502. Similarly, a bottom frame portion can comprise a pair of suspension arms 502. Referring to FIG. 8, left-end and right-end frame portions can comprise wheel frames 600L and 600R, respectively. The top, bottom, left-end and right-end frame portions of the forward frame can have end locations pivotally connected to form an articulated rectangular parallelogram structure. Referring to FIG. 9, the left-end and right-end frame portions can each include a rotatable wheel 640 mounted thereon and extending perpendicularly outward from the forward frame. Referring to FIG. 7, a substantially vertical steering joint includes headpost bolt 414 and is located centrally within the rectangular parallelogram structure. The steering joint pivotally connects the rearward frame with the top and bottom portions of the forward frame. Referring to FIG. 4A and FIG. 8, a roller track can include two semi-circular tracks 212 located centrally within the parallelogram structure about the steering axis and pivotally connected to the steering joint. The roller track pivoting axis is perpendicular to the steering axis. Referring to FIG. 5, a left-intermediate frame portion can include strut 300L located between the steering joint and the left end frame portion wherein the left-intermediate frame portion ends are pivotally connected to the upper and lower frame portions. Still referring to FIG. 5, a right-intermediate frame portion can include strut 300R located between the steering joint and the right-end frame portion wherein the right-intermediate frame portion ends are pivotally connected to the upper and lower frame portions. Still referring to FIG. 5, a plurality of forward frame rollers 400 are attached to the left-intermediate and right-intermediate frame portions and extend toward the steering joint wherein the frame rollers are arranged to roll upon the rotating roller track. Refer now to FIG. 16A, FIG. 17 and FIG. 18. Microcomputer 610, hall effect sensor 730 and gimbal actuator 216 comprise components needed to determine vehicle velocity and to pivot the roller track to a predefined angle that will provide vehicle sideward tilting to improve vehicle stability when turning. The method for steering and tilting the three-wheeled vehicle comprises: pivoting the roller track to a predefined angle calculated using the vehicle velocity on the traveling surface, and then rotating the forward frame about the steering axis to a desired steering angle whereby the frame rollers interact with the roller track to urge the left-intermediate and right-intermediate frame members in substantially vertical and opposite directions relative to the roller track pivot axis thereby urging the forward frame parallelogram structure into a trapezoidal configuration thereby causing the forward wheels and rear frame to tilt toward the steering direction. This arrangement of components within this method causes the forward wheels and rear frame tilting to be mechanically driven by the forward frame steering rotation and the roller track pivot angle. Therefore the forward wheels and rear frame sideward tilt angle is an explicit function of the steering angle and roller track pivot angle.

While the present embodiments have been described in connection with the various figures, it is to be understood that other similar embodiments may be used or modifications and additions may be made to the described embodiment for performing the same function as the disclosed subject matter without deviating therefrom. All such embodiments are contemplated as within the scope of the present disclosure.

What is claimed:

1. A three-wheeled tilting vehicle comprising:
a rearward frame including a single rear wheel and a forward frame including two forward wheels, wherein the forward frame is pivotally connected to the rearward frame by a substantially vertical steering joint near a forward end of the rearward frame whereby vehicle steering is provided by rotating the forward frame about the vertical steering joint relative to the rearward frame;
the forward frame further including left and right wheel frames that are laterally spaced apart wherein each wheel frame has a laterally and outwardly extending axle with a forward wheel rotatably mounted thereon;
the forward frame further including a plurality of upper suspension arms and a plurality of lower suspension arms wherein the suspension arms span the distance between the wheel frames, are spaced apart with ends pivotally connected to the wheel frames thereby forming an articulated rectangular parallelogram structure;
the forward frame further including a first center beam spanning the distance between the upper suspension arms and pivotally connected to center locations on the upper suspension arms wherein the first center beam cooperates with articulation of the rectangular parallelogram structure;
the forward frame further including a second center beam spanning the distance between the lower suspension arms and pivotally connected to center locations on the lower suspension arms wherein the second center beam cooperates with articulation of the rectangular parallelogram structure;
the forward frame further including left and right frame struts pivotally connected to the upper and lower suspension arms at intermediate locations between the wheel frames and vertical steering joint wherein the frame struts cooperate with articulation of the rectangular parallelogram structure and wherein each frame strut has a gimbal roller mounted thereon that extends laterally and inwardly toward the vertical steering joint;
a gimbal assembly pivotally connected to the rear frame upon the vertical steering joint between the first and second center beams wherein the gimbal assembly pivot axis is substantially perpendicular to and intersects the vertical steering joint axis, wherein the gimbal assembly includes a plurality of roller tracks configured to be in rolling engagement with the gimbal rollers when the forward frame is rotated about the vertical steering joint;
and a gimbal actuator positioned to rotate the gimbal assembly about its pivoting axis from a substantially level orientation to a forward tilted orientation thereby rotating the gimbal roller tracks from a substantially level orientation to a forward tilted orientation;
whereby a rotation of the forward frame about the vertical steering axis to a desired steering angle and a forward tilted orientation of the gimbal assembly cause the gimbal rollers to interact with the gimbal roller tracks in a rolling and translational manner that urges the forward frame articulated rectangular parallelogram structure to move from a rectangular shape into a trapezoidal shape thereby providing forward wheel sideward tilting and rearward frame sideward tilting toward the steering direction.

2. The three-wheeled tilting vehicle of claim 1 further including a control unit that is arranged to determine vehicle speed and provide commands to the gimbal actuator thereby actively rotating the gimbal assembly according to vehicle speed.

3. The three-wheeled tilting vehicle of claim 1 further including a tilt actuator with a first pivotal connection to a location on an upper suspension arm adjacent one end of the upper suspension arm and a second pivotal connection to a location on a lower suspension arm adjacent one end of the lower suspension arm, wherein the upper and lower suspension arms are in the same vertical plane and the pivotal connections are located on opposing ends of the upper and lower suspension arms.

4. The three-wheeled tilting vehicle of claim 1 further including a seat with an articulated seat frame suspension comprising a plurality of four bar mechanisms that include the upper suspension arms and wheel frames whereby the seat remains substantially level when the three-wheeled vehicle exhibits wheel and rearward frame sideward tilting.

5. The three-wheeled tilting vehicle of claim 1 further including a passenger footboard pivotally attached to the left and right wheel frames whereby the footboard can be selectively rotated between a predominantly horizontal traveling position and a substantially vertical loading and unloading position.

6. A wheeled vehicle for carrying passengers on a traveling surface comprising:
a plurality of wheels including two laterally spaced-apart forward wheels and one or more rear wheels;
a passenger seat with a horizontal seating surface including a seat front edge located laterally between the forward wheels and vertically above the center axis of a forward wheel;
one or more frame members upon which the wheels and the passenger seat are mounted;
and a passenger footboard located below the seat front edge wherein the footboard is pivotally mounted to at least one frame member whereby the footboard can be selectively rotated between a predominantly horizontal traveling position and a substantially vertical loading and unloading position.

7. The wheeled vehicle of claim 6 wherein the pivot axis of the footboard is substantially parallel to the seat front edge.

8. The wheeled vehicle of claim 6 wherein at least one portion of the footboard is configured to be adjacent the traveling surface when positioned in the loading and unloading position thereby providing a restraint against forward vehicle tipping about the vehicle forward wheels.

9. The wheeled vehicle of claim 6 wherein the footboard is inclined rearward within the range of ten to thirty degrees when in the traveling position.

10. An apparatus for carrying passengers usable with a vehicle on a traveling surface comprising:
a seat including a substantially horizontal seating surface with a seat forward edge;
a moveable footboard located below the seating surface forward edge, wherein the footboard is selectively rotatable between a predominantly horizontal traveling position and a substantially vertical loading and unloading position, and wherein the footboard rotation occurs about an axis substantially parallel to the seating surface forward edge;
and a mounting frame that attaches to the seat and further includes pivoting attachments to the footboard.

11. A method for steering and tilting a three-wheeled vehicle operated on a traveling surface, the vehicle including a rearward frame with a single rotatable wheel, a forward frame including top, bottom, left-end and right-end frame portions each with end locations pivotally connected to form an articulated rectangular parallelogram structure, wherein the left-end and right-end frame portions each include a rotatable wheel mounted thereon and extending perpendicularly outward from the forward frame, a substantially vertical steering joint located centrally within the rectangular parallelogram structure and pivotally connecting the rearward frame with the top and bottom portions of the forward frame, a roller track located centrally within the parallelogram structure about the steering axis and pivotally connected to the steering joint wherein the roller track pivoting axis is perpendicular to the steering axis, a left-intermediate frame portion located between the steering joint and the left end frame portion wherein the left-intermediate frame portion ends are pivotally connected to the upper and lower frame portions, a right-intermediate frame portion located between the steering joint and the right-end frame portion wherein the right-intermediate frame portion ends are pivotally connected to the upper and lower frame portions, and a plurality of forward frame rollers attached to the left-intermediate and right-intermediate frame portions and extending toward the steering joint wherein the frame rollers are arranged to roll upon the rotating roller track, the method comprising: pivoting the roller track to a predefined angle calculated using the vehicle velocity on the traveling surface; and rotating the forward frame about the steering axis to a desired steering angle whereby the frame rollers interact with the roller track to urge the left-intermediate and right-intermediate frame members in substantially vertical and opposite directions relative to the roller track pivot axis thereby urging the forward frame parallelogram structure into a trapezoidal configuration thereby causing the forward wheels and rearward frame to tilt sideward toward the steering direction thereby increasing vehicle stability while turning.
